(19) United States
(12) Patent Application Publication
(10) Pub. No.: US 2026/0126410 A1
(43) Pub. Date: May 7, 2026

(54) ROBUST TAPER SEAL MICRO-CHANNEL MEMBRANE FOR A HIGH TEMPERATURE REFERENCE ELECTRODE

(71) Applicant: HiFunda, LLC, Salt Lake City, UT (US)

(72) Inventors: Lee C. Sorensen, West Jordan, UT (US); Thomas A. Meaders, West Valley City, UT (US); James J. Steppan, Park City, UT (US); Byron S. Millet, Woods Cross, UT (US)

(21) Appl. No.: 19/379,325

(22) Filed: Nov. 4, 2025

Related U.S. Application Data
(60) Provisional application No. 63/716,668, filed on Nov. 5, 2024.

(51) Int. Cl. G01N 27/333; G01N 27/30

(52) U.S. Cl. CPC G01N 27/333; G01N 27/301

(57) ABSTRACT

A micro-channel membrane for use with high-temperature molten salts used with high-temperature reference electrodes (HTREs). The micro-channel membrane includes a ring having an opening with an opening surface and a plug positioned within the opening with a plug surface. The opening surface and the plug surface contact and interface with each other to form a plurality of micro-channels. The opening surface and the plug surface may be tapered. The opening surface and/or the plug surface may have a surface configuration to facilitate formation of the micro-channels, such as a plurality of facets, a helical channel, a roughened surface, a channel pattern, or a knurled surface pattern. One or more tack welds may secure the plug within the ring. A method for making the micro-channel membrane may include measuring a leak rate through the micro-channels and securing the plug when a target leak rate is measured.

### CROSS-REFERENCE TO RELATED APPLICATION

This application claims the benefit of U.S. Provisional Application No. 63/716,668, filed Nov. 5, 2024, the entire contents of which are incorporated by reference.

### STATEMENT REGARDING FEDERALLY SPONSORED RESEARCH OR DEVELOPMENT

This invention was made with government support under Award Number: DE-SC0020579 awarded by the U.S. Department of Energy and titled, Stable High-Temperature Molten Salt Reference Electrodes. The government has certain rights in the invention.

### BACKGROUND

The disclosed invention relates to a micro-channel membrane suitable for use with high-temperature molten salts used with high-temperature reference electrodes (HTREs).

A reference electrode must have ionic communication between the reference salt and the test melt through a membrane. A high-temperature reference electrode (HTRE) for molten salt systems must have a membrane that can withstand the high melt temperatures of the salt and is chemically compatible with the reference salt and the molten test salt. Methods of achieving ionic communication through high-temperature membranes are through either ionically conductive ceramics, ionically-conductive salt melts, or micro-sized channels in a membrane that are typically less than 10 microns (0.0004 inch).

High rates of mass transfer are not required for ionic communication and not desired as the reference melt will be contaminated with the test melt leading to HTRE voltage drift. Mass transfer is the result of pressure and/or concentration gradients between the reference compartment of the HTRE and the test melt. Pressure-driven mass transfer of the reference salt is minimized by incorporation of a vent in the HTRE for pressure equalization during heating. Diffusion-driven mass transfer is minimized by incorporating the same test melt chemistry, e.g. FLiNaK, in both the reference compartment and the test cell. Mass transfer of reference salt is minimized by the high mass transfer resistance of the microchannels. There is a delicate balance between minimizing mass transfer and still maintaining ionic communication. For example, if the leak rate of the metal membrane is zero, then there is no mass transfer, but no ionic communication and the HTRE won't function. However, if the metal membrane has a very low leak rate and its microchannels are filled with high-temperature molten salts (HTMS), it will have low mass transfer, good ionic communication, and good HTRE performance. Ceramic membranes can easily break and are incompatible with fluoride-based molten salts. Membranes using micro-channels have the advantage that they can be made from metal for improved chemical compatibility and robustness. However, creating microchannels on the order of 1 micron diameter or less is a challenging process.

It is possible to use laser drilling to make the channels, but the depth of cut is limited to about 0.005 inches and there are long lead times and limited suppliers with this capability. HTREs built with these thin membranes have failed under pressure during freeze/thaw cycles of the reference salt.

Porous metal membranes can also be used, but these have been observed to degrade during freeze/thaw cycles, require pore forming processes that can be complex to get repeatable leak rates, or by compressing metal foam to get the desired leak rate, which can also lead to variability in the leak rates depending on the resulting number of open channels and paths.

There is a need in the art for a membrane having micro-channels for use with HTREs which is robust and easily manufactured with a repeatable assembly process.

### SUMMARY

The disclosed invention relates to micro-channel membranes suitable for use with high-temperature molten salts (HTMS) used with high-temperature reference electrodes (HTREs). The disclosed invention further includes a robust and repeatable method of making a micro-channel membrane. The membrane can be much thicker than that of a laser-drilled membrane, thus enabling the membrane to withstand higher pressures and providing more robustness. The membrane is designed for manufacturing and is easy to assemble with a repeatable assembly process.

In some disclosed embodiments, a micro-channel membrane for use with high-temperature molten salts used with high-temperature reference electrodes (HTREs) includes a ring having an opening and a plug disposed within the opening. The ring opening defines an opening surface. The plug defines a plug surface. The opening surface and the plug surface contact and interface with each other to form a plurality of micro-channels.

The formed micro-channels typically have a cross-sectional size less than 10 microns. In some embodiments the cross-sectional size ranges from about 0.5 micron to 10 microns. In some embodiments the micro-channels have a cross-sectional size of about 0.5, 1, 1.5, 2, 2.5, 3, 3.5, 4, 4.5, 5, 5.5, 6, 6.5, 7, 7.5, 8, 8.5, 9, 9.5, or 10 microns, where any of the stated values can form an upper or lower endpoint of a range.

In some embodiments the plug surface or the opening surface comprises a plurality of facets. In some embodiments the plug surface or the opening surface comprises a helical channel. In some embodiments the plug surface or the opening surface comprises a roughened surface. In some embodiments the plug surface or the opening surface comprises a channel pattern. In some embodiments the plug surface or the opening surface comprises a knurled surface pattern.

In some nonlimiting embodiments, the ring opening is tapered, having a tapered opening surface. In some embodiments the plug is tapered, having a tapered plug surface. In some embodiments the tapered opening surface and the tapered plug surface contact and interface with each other to form a plurality of micro-channels.

In some embodiments the tapered plug surface or the tapered opening surface comprises a plurality of facets. In some embodiments the tapered plug surface or the tapered opening surface comprises a helical channel. In some embodiments the tapered plug surface or the tapered opening surface comprises a roughened surface. In some embodiments the tapered plug surface or the tapered opening surface comprises a channel pattern. In some embodiments the tapered plug surface or the tapered opening surface comprises a knurled surface pattern.

In some nonlimiting embodiments, the micro-channel membrane includes one or more tack welds to secure the plug within the ring opening. In some embodiments the tack welds are positioned to fully or partially close off micro-channels. In some embodiments the tack welds are porous.

In some embodiments, the micro-channel membrane comprises micro-channels having a cross-sectional size less than 10 microns. In some nonlimiting embodiments, the micro-channel membrane has a helium gas leak rate in the range from 1×10⁻⁵ atm·cm³/min to 0.1 atm·cm³/min. In some nonlimiting embodiments, the micro-channel membrane has a helium gas leak rate of about 1×10⁻⁵ atm·cm³/min, 5×10⁻⁵ atm·cm³/min, 1×10⁻⁴ atm·cm³/min, 5×10⁻⁴ atm·cm³/min, 1×10⁻³ atm·cm³/min, 5×10⁻³ atm·cm³/min, 1×10⁻² atm·cm³/min, 5×10⁻² atm·cm³/min, and 0.1 atm·cm³/min, where any of the stated values can form an upper or lower endpoint of a range. Helium leak detection is used to quantify the leak rate of the metal membrane in a repeatable manner without contaminating the membrane with HTMS.

The disclosed invention further includes a robust and repeatable method of making a micro-channel membrane. An embodiment of the disclosed method includes the step of pressing a plug within a ring. The ring includes a ring opening. The plug includes a plug surface and the ring opening includes an opening surface. The opening surface and the plug surface contact and interface with each other to form a plurality of micro-channels.

The disclosed method of making a micro-channel membrane further includes the step of controlling a force and/or distance of pressing the plug within the ring to control a cross-sectional size of the plurality of micro-channels and/or a leak rate through the plurality of micro-channels. The disclosed method further includes the step of securing the plug within the ring.

In some embodiments of the disclosed method, a leak rate through the plurality of micro-channels is measured, and the step of securing the plug occurs when a target leak rate is measured. In some embodiments the target leak rate is a gas leak rate in the range from 1×10⁻⁵ atm·cm³/min to 0.1 atm·cm³/min. In some embodiments, the target leak rate is a gas leak rate in the range from 1×10⁻⁴ atm·cm³/min to 5×10⁻³ atm·cm³/min. In some nonlimiting embodiments, the target leak rate is about 1×10⁻⁵ atm·cm³/min, 5×10⁻⁵ atm·cm³/min, 1×10⁻⁴ atm·cm³/min, 5×10⁻⁴ atm·cm³/min, 1×10⁻³ atm·cm³/min, 5×10⁻³ atm·cm³/min, 1×10⁻² atm·cm³/min, 5×10⁻² atm·cm³/min, or 0.1 atm·cm³/min, where any of the stated values can form an upper or lower endpoint of a range.

In some embodiments of the disclosed method, the step of securing the plug within the ring comprises applying one or more tack welds to secure the plug within the ring.

In some embodiments the plug surface or the opening surface comprises a plurality of facets. In some embodiments the plug surface or the opening surface comprises a helical channel. In some embodiments the plug surface or the opening surface comprises a roughened surface. In some embodiments the plug surface or the opening surface comprises a channel pattern. In some embodiments the plug surface or the opening surface comprises a knurled surface pattern.

In some nonlimiting embodiments, the ring opening is tapered, having a tapered opening surface. In some embodiments the plug is tapered, having a tapered plug surface. In some embodiments the tapered opening surface and the tapered plug surface contact and interface with each other to form a plurality of micro-channels.

In some embodiments the tapered plug surface or the tapered opening surface comprises a plurality of facets. In some embodiments the tapered plug surface or the tapered opening surface comprises a helical channel. In some embodiments the tapered plug surface or the tapered opening surface comprises a roughened surface. In some embodiments the tapered plug surface or the tapered opening surface comprises a channel pattern. In some embodiments the tapered plug surface or the tapered opening surface comprises a knurled surface pattern.

### DESCRIPTION OF THE DRAWINGS

FIGS. 1A to 1C show a tapered seal micro-channel membrane.

FIGS. 2A to 2D show a tapered seal micro-channel membrane where the interfacing surfaces have a plurality of facets on a tapered plug surface.

FIGS. 3A to 4D show a tapered seal micro-channel membrane where the interfacing surfaces have a plurality of facets on a ring opening surface.

FIGS. 4A to 4C show a tapered seal micro-channel membrane where the interfacing surfaces have a helical channel on a tapered plug surface.

FIGS. 5A to 5C show a tapered seal micro-channel membrane where the interfacing surfaces have a helical channel on a ring opening surface.

FIGS. 6A to 6C show a tapered seal micro-channel membrane where the interfacing surfaces have a channel pattern on a tapered plug surface.

FIGS. 7A to 7C show a tapered seal micro-channel membrane where the interfacing surfaces have a channel pattern on a ring opening surface.

FIGS. 8A to 8C show a tapered seal micro-channel membrane where the interfacing surfaces have a knurled surface pattern on a tapered plug surface.

FIGS. 9A to 9B show a tapered seal micro-channel membrane where the interfacing surfaces have a knurled surface pattern on a ring opening surface.

FIGS. 10A and 10B show tack welds to secure the plug within the ring.

FIGS. 11A to 11C show a tapered seal micro-channel membrane assembly and leak test fixture.

### DETAILED DESCRIPTION

The disclosed invention relates to micro-channel membranes suitable for use with high-temperature molten salts (HTMS) used with high-temperature reference electrodes (HTREs). The disclosed invention further includes a robust and repeatable method of making a micro-channel membrane. The discloses micro-channel membranes comprise a plurality of micro-channels which are formed by the interaction of two surfaces.

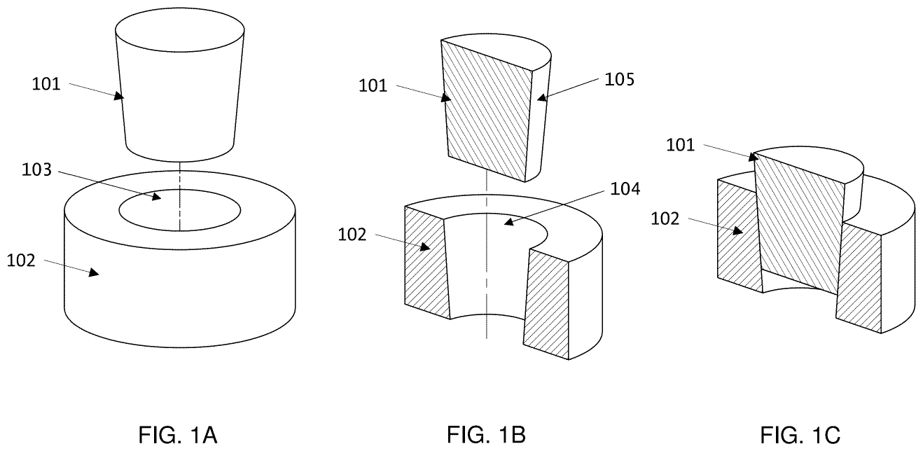

In some disclosed embodiments, the micro-channel membrane may be prepared from a plug that is pressed into a ring, with either the plug, the ring, or both being tapered such that an interference fit occurs when the plug is pressed into the ring. FIGS. 1A to 1C show a tapered seal micro-channel membrane. The tapered seal micro-channel membrane assembly includes a tapered plug 101 and tapered ring 102. The ring 102 has an opening 103. The opening 103 has an opening surface 104. The plug has a plug surface 105. The opening surface 104 and the plug surface 105 contact and interface with each other to form a plurality of micro-channels. Having both the plug and ring tapered has the advantage of creating self-alignment between the plug and ring.

The plug and ring may be fabricated of a robust material suitable for use with molten salts. Non-limiting examples of suitable materials include stainless steel 316, silver, and nickel 201.

The dimensions of the plug and ring can vary. A typical outside diameter (OD) of the tapered ring is ¼ inch, ⅜ inch, and ½ inch. The tapered plug is scaled proportionally as shown in the drawings, with a typical outside diameter (OD) from ⅛ inch to ⅜ inch. The taper angle may range from 1 to 20 degrees. In some embodiments, the taper angle is 5 degrees.

Micro-channels are created between the plug surface and the ring opening surface through one or more nonlimiting methods such a roughened surface, a plurality of surface facets, one or more helical channels, a channel pattern, or a knurled surface pattern.

The roughened surface of the tapered plug, ring, or both can be controlled to create micro-channels through the surface roughness. The roughness can be controlled via a machining process, chemical etching, grit blasting, or any other standard surface treating method to provide a controlled surface finish. In some non-limiting embodiments, the controlled surface finish is in the range of 2 to 500 pinches rms. In some embodiments, the controlled surface finish is in the range of 32 to 63 pinches rms.

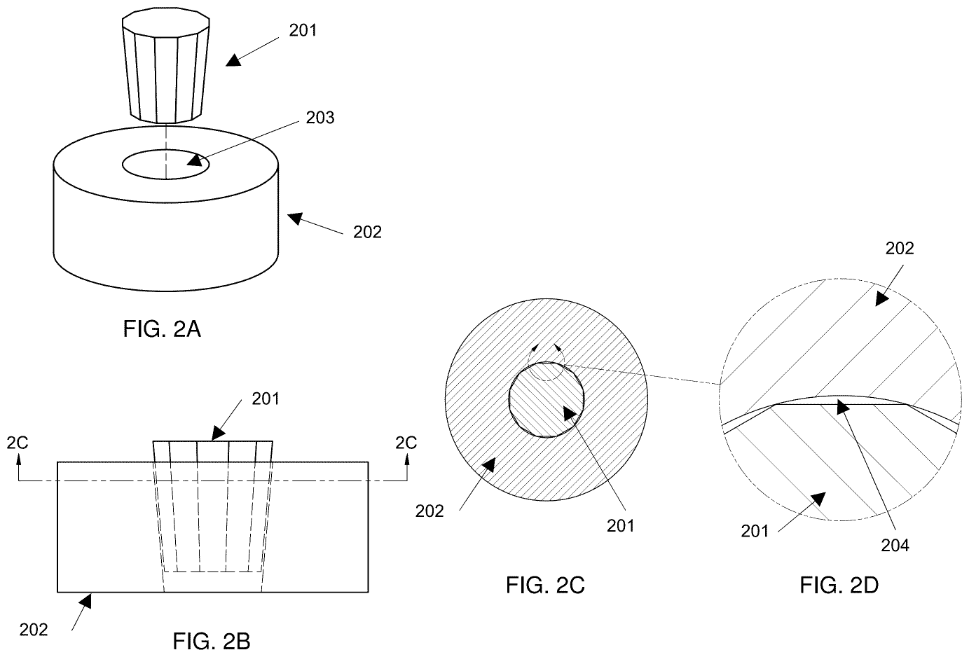

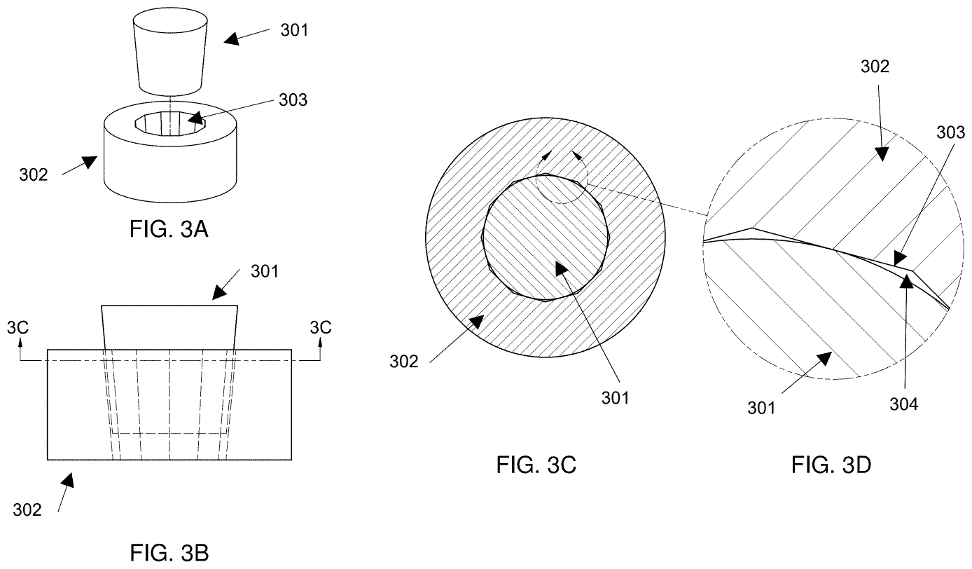

FIGS. 2A to 2D and 3A to 3D show other embodiments of the tapered seal micro-channel membrane. Micro-channels are formed from the interaction of two surfaces, at least one of which comprises faceted edges. In FIGS. 2A to 2D, the tapered seal membrane assembly includes a faceted tapered plug 201 and tapered ring 202 having a ring opening 203. As shown in the enlarged view of FIG. 2D, the interaction between the faceted tapered plug 201 and the tapered ring 202 forms a plurality of micro-channels 204 between the ring 202 and edges of the faceted tapered plug 201.

Using faceted edges (polygon) for either the plug or the ring opening creates channels between the faceted edges and the mating round face as shown in FIGS. 2A through 2D. The more faces of the polygon, the smaller the area of the channel will be.

In FIGS. 3A to 3D, the tapered seal membrane assembly includes a tapered plug 301 and tapered ring 302 having a faceted ring opening 303. As shown in the enlarged view of FIG. 3D, the interaction between the tapered plug 301 and the faceted ring opening 303 forms a plurality of micro-channels 304 between the tapered plug 301 and edges of the faceted ring opening 303.

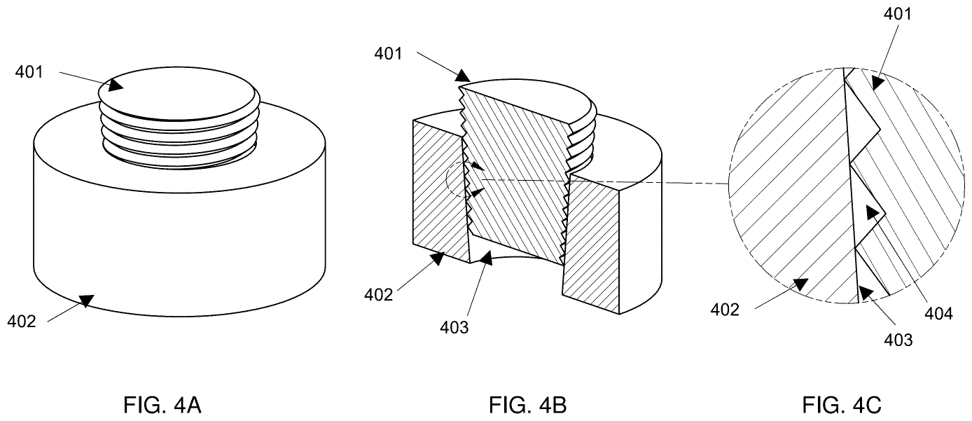

FIGS. 4A to 4C and FIGS. 5A to 6C show other embodiments of the tapered seal micro-channel membrane. Micro-channels are formed from the interaction of two surfaces, at least one of which comprises a helical channel. In FIGS. 4A to 4C, the tapered seal membrane assembly includes a helical channel tapered plug 401 and tapered ring 402 having a ring opening 403. As shown in the enlarged view of FIG. 4C, the interaction between the helical channel tapered plug 401 and the ring opening 403 of the tapered ring 402 forms a plurality of microchannels 404 between the ring 402 and the helical channel tapered plug 401.

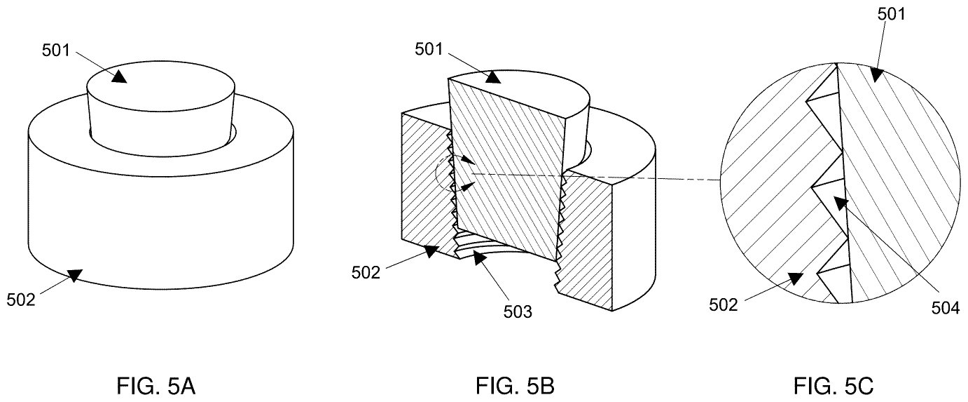

In FIGS. 5A to 5C, the tapered seal membrane assembly includes a tapered plug 501 and a tapered ring 502 having a helical channel ring opening 503. As shown in the enlarged view of FIG. 5C, the interaction between the tapered plug 501 and the helical channel ring opening 503 of the tapered ring 502 forms a plurality of microchannels 504 between the tapered plug 501 and the tapered ring 502.

A channel pattern can be machined into the tapered plug or ring. The pattern can take any form, but simple examples are grooves extending along the length of the plug surface or ring opening surface, a single or multiple helical lines around the circumference, or a knurled pattern on the plug or ring opening surface.

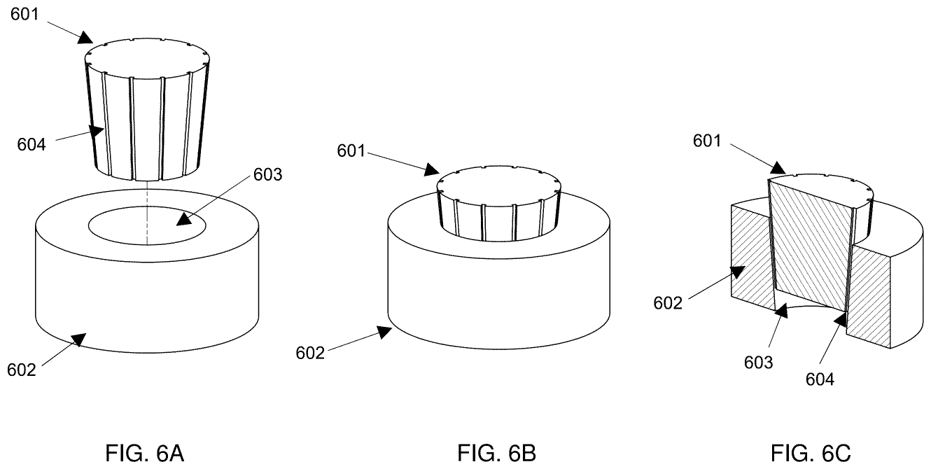

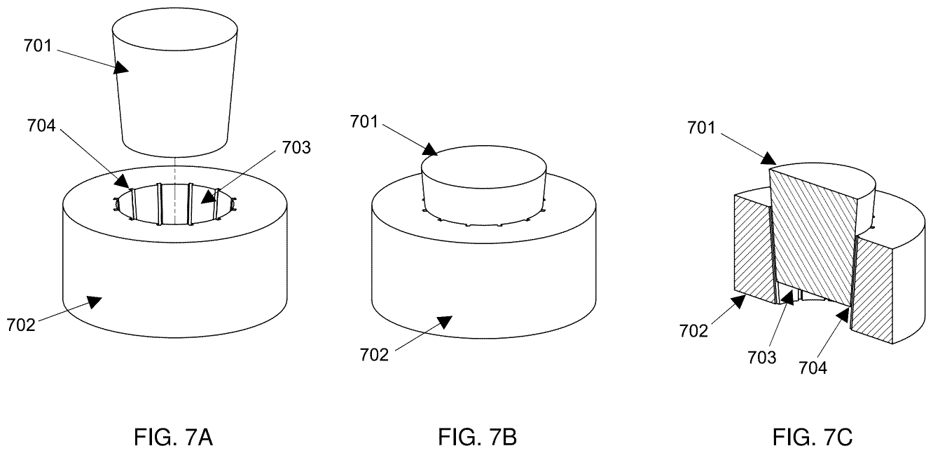

FIGS. 6A to 6C and FIGS. 7A to 7C show other embodiments of the tapered seal micro-channel membrane. Micro-channels are formed from the interaction of two surfaces, at least one of which comprises a channel pattern. In FIGS. 6A to 6C, the tapered seal membrane assembly includes a channel pattern tapered plug 601 and tapered ring 602 having a ring opening 603. As shown in the cross-sectional view of FIG. 6C, the interaction between the channel pattern tapered plug 601 and the ring opening 603 of the tapered ring 602 forms a plurality of microchannels 604 between the ring 602 and the channel pattern tapered plug 601.

In FIGS. 7A to 7C, the tapered seal membrane assembly includes a tapered plug 701 and a tapered ring 702 having a channel pattern ring opening 703. As shown in the cross-sectional view of FIG. 7C, the interaction between the tapered plug 701 and the channel pattern ring opening 703 of the tapered ring 702 forms a plurality of microchannels 704 between the tapered plug 701 and the tapered ring 702.

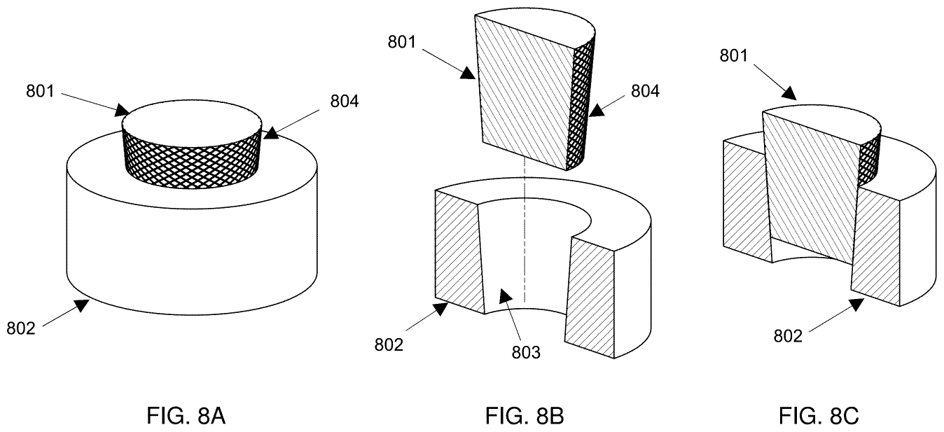

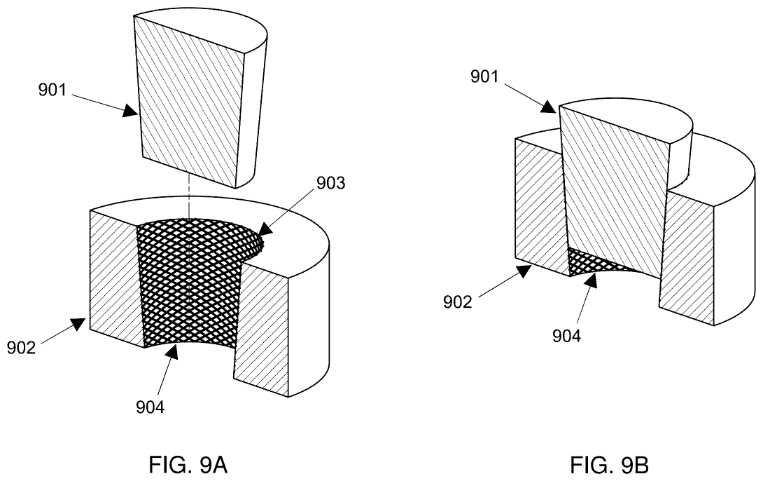

FIGS. 8A to 8C and FIGS. 9A to 9B show other embodiments of the tapered seal micro-channel membrane. Micro-channels are formed from the interaction of two surfaces, at least one of which comprises a knurled pattern. In FIGS. 8A to 8C, the tapered seal membrane assembly includes a knurled pattern tapered plug 801 and tapered ring 802 having a ring opening 803. The interaction between the knurled pattern tapered plug 801 and the ring opening 803 of the tapered ring 802 forms a plurality of microchannels 804 between the ring 802 and the knurled pattern tapered plug 801.

In FIGS. 9A and 9B, the tapered seal membrane assembly includes a tapered plug 901 and a tapered ring 902 having a knurled pattern ring opening 903. The interaction between the tapered plug 901 and the knurled pattern ring opening 903 of the tapered ring 902 forms a plurality of microchannels 904 between the tapered plug 901 and the tapered ring 902.

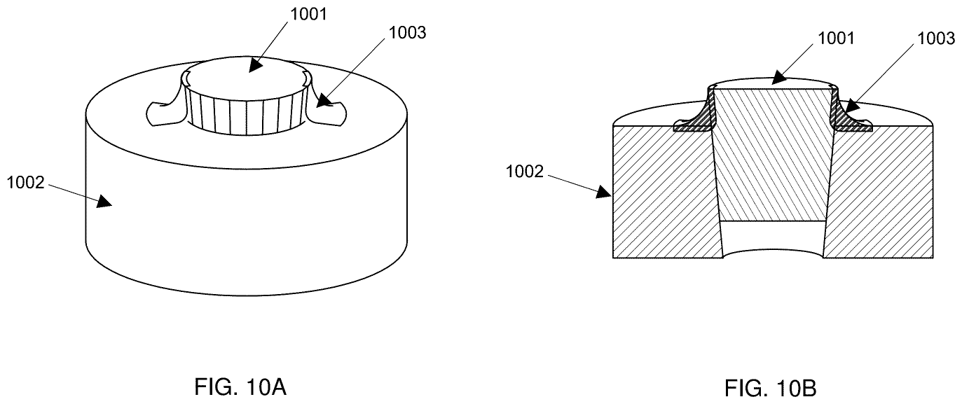

FIGS. 10A and 10B show another embodiment of the tapered seal membrane. The tapered seal membrane assembly includes a tapered plug 1001 and tapered ring 1002. Tack welds 1003 are provided to secure the tapered plug 1001 in position within the tapered ring 1002. Tack welds may also be used to help control leak rate by intentionally covering some of the microchannels with the welds.

As the plug is pressed within the ring, the taper causes high pressure to develop between the plug and ring, causing the materials of each to deform, resulting in a decreased open area of the micro-channels between the two. By controlling the force and/or distance of pressing the plug into the ring, the user can precisely control the leak rate through the microchannels. Once assembled, the membrane plug and ring can be secured together through methods such as tack welding to minimize movement of the plug within the ring during handling and heating of the HTRE, as shown in FIGS. 10A and 10B.

The tack welds can also be used to help control leak rate of the membrane by selectively welding over open channels in the membrane to fully or partially close off the channels. The channels can be partially closed off by either welding over only a portion of the channel, or by using an intentionally porous weld that covers the channel. The porous weld can be made by applying various surface contaminants such as fluxing agents or moisture, disrupting the shielding gas flow or altering its composition with small amounts of air, using welding parameters, and/or welding over small pieces of copper or other metal that vaporizes.

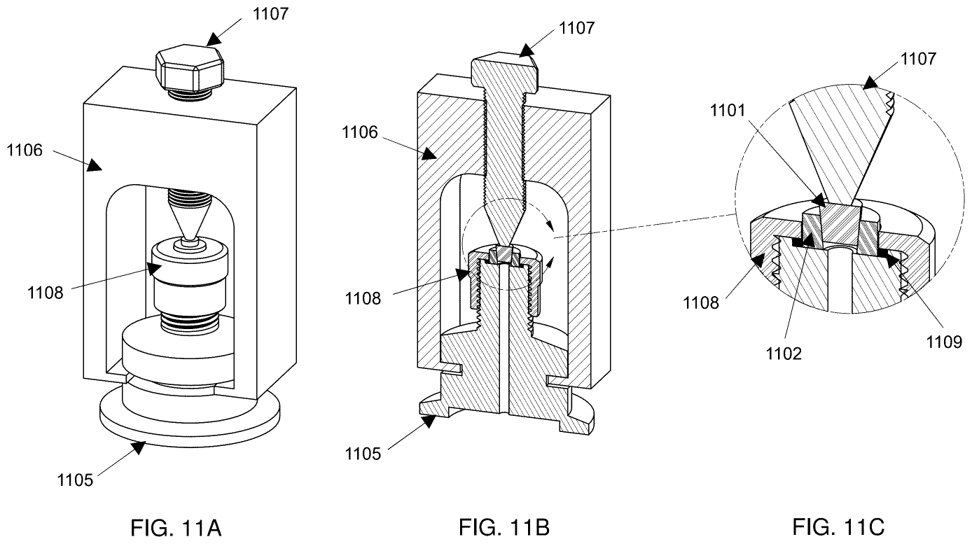

FIGS. 11A to 11C show a tapered seal micro-channel membrane assembly and leak test fixture. The tapered seal micro-channel membrane assembly fixture includes a tapered plug 1101 and tapered ring 1102. A base 1105 connects to a leak test fixture. An arm 1106 provides structural connection between the base 1105 and a lead screw 1107 for pressing the tapered plug 1101 into the tapered ring 1102. FIG. 11C shows an enlarged cross-sectional view including an O-ring seal compression nut 1108 and O-ring 1109.

The resulting leak rate of the assembled tapered seal micro-channel membrane can be measured through standard methods such as pressure decay testing and helium leak testing. To make a membrane with a target leak rate, an assembly fixture was designed that holds the membrane in fluid communication to the leak tester, while a screw clamp is used to press the plug into the ring, as shown in FIGS. 11A through 11C.

The tapered seal micro-channel membrane assembly and leak test fixture allows for real-time leak rate measurements to be made so that a target leak rate can be achieved. Once the target leak rate is achieved, the assembly fixture is removed from the leak test equipment while still holding the ring and plug securely in place so that they do not shift and change the leak rate. While held together by the fixture, a weld or other method to secure the plug to the ring can be made prior to removing the tapered seal micro-channel membrane from the assembly fixture.

Empirical data can be used to correlate the helium leak rate and/or pressure decay leak rates to mass transfer and ionic breakthrough times through the membrane, which are more practical measurements for specifying a reference electrode membrane. Table 1 shows samples of helium leak rates of three different tapered seal micro-channel membranes.

TABLE 1
Tapered Seal Micro-channel Membrane Helium Gas Leak Rates

| | Helium Gas Leak Rate |
|---|---|
| Membrane | (atm-ccm) |
| SP-002 | 0.138 |
| TM-009 | 0.291 |
| TM-010 | 0.0608 |

Membrane SP-002 used surface finish and plug insertion force/distance to control the leak rate. Surface finish for both the plug and the ring was left as-machined and was not intentionally roughened. This was assembled using a hydraulic press instead of the assembly and leak test fixture described in relation to FIGS. 11A to 11C. Membrane TM-009 used a 14-sided faceted plug. It was assembled and tested using the assembly and leak test fixture described in relation to FIGS. 11A to 11C to press in the plug until the desired leak rate was achieved. Membrane TM-010 used a 14-sided faceted plug. It was assembled and tested using the assembly and leak test fixture described in relation to FIGS. 11A to 11C as well as additional welds over gaps between the faceted plug and the ring to control the leak rate.

The following are unique features and advantages of the disclosed taper seal micro-channel membrane.

A micro-channel membrane for a high temperature reference electrode that has a controlled leak rate set by pressing a tapered plug within a tapered ring.

Micro-channels can be created in the ring to help control the leak rate. The microchannels may be created through methods such as 1) controlled surface roughness, 2) faceted edges on either the plug or the ring, 3) patterns cut into the ring such as linear grooves, helical grooves (screw), or a knurled pattern.

An assembly fixture to press control the amount that the plug is pressed into the ring to control the leak rate. The assembly fixture attaches to a leak tester so that real-time leak measurements can be measured. The fixture holds the plug stable in the ring until it can be fixed in place through methods such as tack welding.

Welds to secure the plug into the ring can be used to help control leak rate by intentionally covering some of the microchannels with the welds. The welds can also be porous so that a small leak rate is allowed through the weld, thus allowing additional control over the overall leak rate of the membrane.

1. A micro-channel membrane for use with high-temperature molten salts used with high-temperature reference electrodes (HTREs) comprising:
a ring having an opening, wherein the opening comprises an opening surface;
a plug disposed within the opening, wherein the plug comprises a plug surface and wherein the opening surface and the plug surface contact and interface with each other to form a plurality of micro-channels.

2. The micro-channel membrane according to claim 1, wherein the opening surface comprises a tapered opening surface and wherein the plug surface comprises a tapered plug surface.

3. The micro-channel membrane according to claim 2, wherein the tapered plug surface or the tapered opening surface comprises a plurality of facets.

4. The micro-channel membrane according to claim 2, wherein the tapered plug surface or the tapered opening surface comprises a helical channel.

5. The micro-channel membrane according to claim 2, wherein the tapered plug surface or the tapered opening surface comprises a controlled surface finish having a predetermined surface roughness.

6. The micro-channel membrane according to claim 2, wherein the tapered plug surface or the tapered opening surface comprises a channel pattern.

7. The micro-channel membrane according to claim 2, wherein the tapered plug surface or the tapered opening surface comprises a knurled surface pattern.

8. The micro-channel membrane according to claim 1, wherein the micro-channel membrane further comprises one or more tack welds to secure the plug within the ring opening.

9. The micro-channel membrane according to claim 8, wherein the tack welds are positioned to fully or partially close off micro-channels.

10. The micro-channel membrane according to claim 8, wherein the tack welds are porous.

11. The micro-channel membrane according to claim 1, wherein the plurality of micro-channels have a cross-sectional size less than 10 microns.

12. The micro-channel membrane according to claim 1, wherein the micro-channel membrane comprises a gas leak rate in the range from 1×10⁻⁵ atm·cm³/min to 0.1 atm·cm³/min.

13. A method for making a micro-channel membrane for use with high-temperature molten salts used with high-temperature reference electrodes (HTREs) comprising:
pressing a plug within a ring, wherein the plug comprises a plug surface and the ring comprises an opening having an opening surface, wherein the opening surface and the plug surface contact and interface with each other to form a plurality of micro-channels;
controlling a force and/or distance of pressing the plug within the ring to control a cross-sectional size of the plurality of micro-channels and/or a leak rate through the plurality of micro-channels; and
securing the plug within the ring.

14. The method for making a micro-channel membrane according to claim 13, further comprising measuring a leak rate through the plurality of micro-channels and wherein the step of securing the plug occurs when a target leak rate is measured.

15. The method for making a micro-channel membrane according to claim 14, wherein the target leak rate is a gas leak rate in the range from 1×10⁻⁴ atm·cm³/min to 5×10⁻³ atm·cm³/min.

16. The method for making a micro-channel membrane according to claim 13, wherein the opening surface comprises a tapered opening surface and wherein the plug surface comprises a tapered plug surface.

17. The method for making a micro-channel membrane according to claim 13, wherein the step of securing the tapered plug within the tapered ring comprises applying one or more tack welds to secure the tapered plug within the tapered ring.

18. The method for making a micro-channel membrane according to claim 16, wherein the tapered plug surface or the tapered opening surface comprises a plurality of facets.

19. The method for making a micro-channel membrane according to claim 16, wherein the tapered plug surface or the tapered opening surface comprises a helical channel.

20. The method for making a micro-channel membrane according to claim 16, wherein the tapered plug surface or the tapered opening surface comprises a roughened surface.

21. The method for making a micro-channel membrane according to claim 16, wherein the tapered plug surface or the tapered opening surface comprises a channel pattern.

22. The method for making a micro-channel membrane according to claim 16, wherein the tapered plug surface or the tapered opening surface comprises a knurled surface pattern.
